(19) United States
(12) Patent Application Publication
(10) Pub. No.: US 2024/0250477 A1
(43) Pub. Date: Jul. 25, 2024

(54) SOCKET, SOCKET CONNECTOR, CONTACT ELEMENT AND CONNECTION ASSEMBLY

(71) Applicant: Tyco Electronics France SAS, Pontoise (FR)

(72) Inventors: Sundareshan M D, Pontoise (FR); Xavier ROUILLARD, Pontoise (FR); Imad SMIRANI, Pontoise (FR); Pierre LEPRIVEY, Pontoise (FR)

(21) Appl. No.: 18/413,439

(22) Filed: Jan. 16, 2024

(30) Foreign Application Priority Data
Jan. 24, 2023 (EP) 23305082.2

(51) Int. Cl. H01R 13/64; H01R 13/11

(52) U.S. Cl. CPC H01R 13/64; H01R 13/11

(57) ABSTRACT

A socket for a high-voltage socket connector includes a conductor connection section adapted for being connected to a conductor of a cable, and a pin receptacle section adapted for receiving a pin of a mating plug connector along a mating direction, wherein the pin receptacle section is integral with the conductor connection section, and wherein the pin receptacle section comprises at least two free ends that extend in opposite circumferential directions around the mating direction and at least in sections face each other.

### CROSS REFERENCE TO RELATED APPLICATIONS

This application claims the benefit of EP application Ser. No. 23/305,082.2 filed 24 Jan. 2023, the subject matter of which is herein incorporated by reference in its entirety.

### BACKGROUND OF THE INVENTION

The subject matter herein relates to a socket for a high-voltage socket connector, a socket connector, a contact element for mating with the socket, and a connection assembly.

Previous sockets are difficult to manufacture and to assemble.

There is a need for a socket that is easy to manufacture and to assemble, while allowing a mechanically stable contacting of a mating contact element.

### BRIEF DESCRIPTION OF THE INVENTION

In one embodiment, a socket is provided that is easy to manufacture and to assemble, while allowing a mechanically stable contacting of a mating contact element.

In an embodiment, a socket is provided for a high-voltage socket connector including a conductor connection section adapted for being connected to a conductor of a cable, and a pin receptacle section adapted for receiving a pin of a mating plug connector along a mating direction, wherein the pin receptacle section is integral with the conductor connection section, and wherein the pin receptacle section comprises at least two free ends that extend in opposite circumferential directions around the mating direction and at least in sections face each other.

In an embodiment, a corresponding socket connector is provided including at least one socket.

In an embodiment, a connection assembly is provided including at least one socket and at least one mating contact element.

The mating contact element is adapted for mating with the socket and is, in particular, pin-shaped.

The fact that the conductor connection section and the pin receptacle section are integral facilitates the manufacturing process. In contrast, previous solutions often comprise two or more parts, which in some cases have shapes that are difficult to manufacture and to assemble. The two free ends opposite each other allow making a mechanically stable connection to the pin.

The solution according to the invention can be further improved by the following developments and advantageous embodiments, which are independent from each other and can be combined arbitrarily, as desired.

The pin receptacle section can comprise at least one first free end that extends along a circumferential direction around the mating direction and a second free end that extends counter to the circumferential direction and at least in sections faces the first free end. The first free end and the second free end thus form the two free ends.

The two free ends can at least be in sections located at the same insertion depth measured along the mating direction. In other words, an insertion depth may exist at which the two free ends are present and face each other.

In particular, two end faces can face each other, the two end faces being located on the two different free ends.

According to one advantageous embodiment, the pin receptacle section comprises at least one open support ring section for radially and axially supporting at least one deflectable contact arm adapted for contacting the pin in a mated state. This can allow an easy contacting of the mating contact element with the contact arm. The term arm describes a part that is attached to, and thus immobile, relative to a base part at one end and deflectable at the other, free end opposite the attached end.

The pin receptacle section can comprise or be a sleeve, i.e. a section that surrounds an inner space around a longitudinal axis, namely the mating direction (or as in the rest of the document a direction parallel to the mating direction).

In order to ensure a correct mating position, the socket can comprise a radially open coding channel adapted to fittingly receive a coding element on the pin along the mating direction. Radial here means directions that are perpendicular to an axial direction of the longitudinal axis.

Preferably, the coding channel extends in the mating direction. According to one embodiment, the coding element has a constant cross section along the mating direction. The coding channel then has at least an open cross section corresponding to the cross section of the coding element.

The open support ring section can extend partially around the axis, which can be parallel to the mating direction.

Preferably, a circumferential width of the coding channel is less than 20%, more preferably less than 10%, and especially less than or 5% of a circumferential length of a closed envelope running along the inner cross section of the pin receptacle section. On the other hand, the circumferential width of the coding channel is preferably greater than 1%, more preferably greater than 2%, and especially greater than or 5% of the circumferential length of the closed envelope. The envelope can be defined as being of minimum length, i.e. a minimum length envelope.

In order to allow a simple configuration, the coding channel can be open towards an open inner space of the pin receptacle section.

According to one embodiment, the open support ring section forms at least part of the coding channel.

The open support ring section can define or delimit the coding channel. Parts or faces of the open support ring section can form parts or faces of the coding channel. For example, at least one free end of the open support ring section can form a sidewall of the coding channel.

Preferably, the at least two free ends partially delimit the coding channel. For example, the open support ring section may delimit a coding channel in the form of a circumferential gap.

In one development, the open support ring section is radially open at the coding channel. This can allow an easy assembly.

The open support ring section can be open perpendicular to the mating direction.

Generally, the coding channel should be adapted to fittingly receive the coding element. In one preferred embodiment, the coding channel is at least in sections complementary to the coding element.

An open inner space, which can be surrounded, defined and/or delimited by the pin receptacle section, can be next to a coding space, which is surrounded, defined and/or delimited by the coding channel. The open inner space and the coding space can be subspaces of a single continuous, preferably integral space. The term space should be understood as meaning an open space where no material is present.

A length of the open support ring section can be greater than 5%, preferably greater than 10%, and especially greater than 20% of a length of the pin receptacle section. On the other hand, the length can be less than 80%, preferably less than 50%, and especially less than 30% of the length of the pin receptacle section. The longer the open support ring section is, the more stable the socket will be. However, a shorter open support ring section can reduce the overall weight. The lengths are to be measured along the axial or mating direction.

In an advantageous embodiment, the socket comprises at least two open support ring sections. This can improve the stability and allow a higher current via two contact arms.

Preferably, the two open support ring sections are located opposite each other regarding the mating direction. Again, this leads to higher stability.

According to one development, the at least two open support ring sections are interconnected to further improve the stability.

For example, the two open support ring sections can be connected by a stabilizing bridge extending along the mating direction. The stabilizing bridge can extend from one open support ring section to the other open support ring section, in particular without intermediate elements.

The stabilizing bridge can be integral with at least one open support ring section, preferably with two or more open support ring sections.

To reduce the weight, the stabilizing bridge can be straight or extend in a straight manner along the mating direction. The stabilizing bridge can be parallel to the mating direction.

In order to keep the weight low, a circumferential width of the stabilizing bridge can be less than 20%, preferably less than 10%, and especially less than or 5% of the circumferential length of the closed envelope running along the inner cross section of the pin receptacle section. On the other hand, in order to provide a stable and safe embodiment, the circumferential width of the stabilizing bridge is preferably greater than 1%, more preferably greater than 2%, and especially greater than or 5% of the circumferential length of the closed envelope.

The pin receptacle section can comprise a spring sleeve in order to allow an easy contacting. The contact arm can be located on or be a part of the spring sleeve. In particular, a plurality of contact arms can form the spring sleeve.

According to one advantageous embodiment, the at least one contact arm is integral with the open support ring section. It can be a section or part of the socket. Such a socket can be easy to manufacture and ensure a safe contacting.

If the contact arm is located on or part of the spring sleeve, the spring sleeve can be integral with the pin receptacle section, the at least one open support ring section, and/or the rest of the socket. This can make the manufacturing simple.

In particular, the socket can be monolithic, i.e. one-piece or integral, including the at least one contact arm. This simplifies the design and facilitates the production.

The open support ring section can extend along the entire length of the pin receptacle section, the length being measured along the mating direction.

The contact arm can protrude from the open support ring section to allow an easy deflection. Preferably, it protrudes radially inwards to contact the mating contact element. It can protrude from the open support ring section along or counter to the mating direction to reduce the risk of damage. The contact arm can be inclined, slanted or transverse to the mating direction

According to a further advantageous embodiment, the at least one contact arm is part of a spring element that is separate from the conductor connection section. This can, for example, allow a modular design as different contact arms and/or spring elements can be added to the same conductor connection section. The spring element can be the spring sleeve.

In order to fix such a separate spring element, at least two opposing stop faces adapted to hold the spring element along and counter to the mating direction can be located in the pin receptacle section, in particular at the at least one open support ring section. The stop faces can face counter to and along the mating direction to allow a safe and simple stopping.

In one development, the stop faces can be located on radially inward protruding protrusions.

In an embodiment that is easy to produce, the socket is a stamped and/or bent part formed from a sheet, in particular a metal sheet. Stamping here refers to a cutting step.

To improve the yield and to allow a simple production, the sheet can be rectangular. The socket can be made from a rectangular metal sheet by cutting out parts located within the rectangular metal sheet only. The corresponding socket has a rectangular outer shape when bent into a planar configuration and viewed from above. Overall, when flattened, the outer shape of the socket can be a flat box or cuboid.

In one preferred embodiment, a ratio of a sheet thickness to the outer diameter of the socket and/or the open support ring section is between 1:10 and 1:4. Such ratio is a good compromise between stability and weight.

In particular, a length of the conductor receptacle section can be equal to a length of the pin receptacle section, the lengths being measured along the mating direction. The overall size can thus be kept low.

To facilitate the mounting and the operation, the socket is preferably mirror-symmetric. In particular, the mirror plane may be perpendicular to the mating direction.

To establish a good connection, the socket may comprise at least two, preferably at least three, more preferably at least four, and especially at least ten contact arms.

The contact arms may be arranged behind each other in the circumferential direction and/or behind each other in the mating direction.

If the socket comprises at least two arms with opposing extension directions, in particular substantially along and counter to the mating direction, an embodiment is possible in which no overall force along or counter to the mating direction acts on the pin, when inserted.

The conductor connection section can, in one embodiment, comprise or be a flat section and/or planar. The plane can be parallel to the mating direction to keep the socket flat and allow a space saving mounting of several sockets in one socket connector.

The conductor connection section may comprise or be a crimp section, thus allowing a safe and easy crimping connection.

In addition to, or alternatively, at least one conductor of a cable can be connected to a socket by an ultrasonically welded connection and/or a soldered connection.

A conductor connection direction of the conductor connection section can be at a right angle to the mating direction. Such a socket can be used for a 90-degree connector.

In a preferred embodiment, the pin receptacle section is located entirely in one of the two half-spaces defined by a planar conductor connection section. This can facilitate the production.

Preferably, the conductor connection section extends at a right angle to the mating direction away from the pin receptacle section. The resulting socket connector can be compact along the mating direction.

The socket may comprise a transition section between the conductor connection section and the pin receptacle section, the transition section having a lower cross section area than the conductor connection section. This can reduce the weight. In particular, these cross sections are taken perpendicular to the direction going from the conductor connection section to the pin receptacle section and/or are parallel to the mating direction.

The transition section can be formed by residual material remaining after at least one unilaterally joined part for example a flap, a prong, or a finger, has been cut and bent to form a part of the pin receptacle section. At least one recess in the transition section may correspond to the unilaterally joined part of the pin receptacle section. Thereby, the weight can be reduced while the pin receptacle section provides sufficient support for the pin. In particular, at least one of the free ends is preferably part of the unilaterally joined part.

In a preferred embodiment of the socket connector, at least two sockets are present, wherein the conductor connection sections of at least two sockets are parallel and arranged at an offset greater than an offset of the corresponding pin receptacle sections. With this solution, the distance between the conductors attached to the sockets can be increased in order to improve the insulation performance and to allow the use of higher voltages.

A preferred mating contact element is pin-shaped and comprises a radially protruding coding element that extends parallel to the mating direction from a tip to a base of the contact element.

In particular, the coding element may protrude radially from a conductive shaft.

According to a preferred embodiment, the coding element is adapted to act as a touch protection bar, which can be a part of a touch protection arrangement. This double function in one part simplifies the configuration. The coding element is preferably made from an electrically insulating material.

The shaft can have a cylindrical outer shape, in particular the shape of a circular cylinder. This can result in a good force distribution.

According to one embodiment, the inner face of the open support ring section is part cylindrical.

Preferably, the socket is adapted for repeated cycles of plugging-in and removing the pin. In contrast thereto, the making of a permanent connection for example by welding, soldering or crimping is not to be covered.

The coding element preferably allows mating of the plug connector and the socket connector only in a predefined rotational configuration around the mating direction or a direction parallel thereto.

The pin receptacle section and/or the open support ring section can, in one embodiment, be open on two sides, in particular along and counter to the mating direction. In a different embodiment, the pin receptacle section and/or the open support ring section are only open at one side.

Preferably, the open support ring section has a constant clear cross section along the mating direction to allow an easy insertion of the pin.

Similarly, the entire open support ring section can have a constant cross section along the mating direction. Such an embodiment can be easy to manufacture.

To allow an easy plug-in, an outermost location along the mating direction can be part of the open support ring section.

The open support ring section may form an entrance for the pin.

In one embodiment, the open support ring section is integral with at least one other part, preferably with all other parts of the pin receptacle section. This can result in a weight saving and easy to produce solution.

The term contacting used in this description in particular relates to electric contacting, i.e. the making of an electrically conductive connection.

The term pin is to be used synonymously with pin-shaped mating contact element.

The invention will now be described in greater detail and in an exemplary manner using advantageous embodiments and with reference to the drawings. The described embodiments are only possible configurations in which, however, the individual features as described above can be provided independently of one another or can be omitted.

### BRIEF DESCRIPTION OF THE DRAWINGS

FIG. 1 shows a schematic perspective, partially exploded view of a first embodiment of a socket together with a mating contact element in the form of a pin;

FIG. 2 shows a schematic cross sectional top view of the embodiment of FIG. 1;

FIG. 3 shows a schematic cross sectional front view of the embodiment of FIG. 1;

FIG. 4 shows a schematic front view of an advantageous arrangement of two sockets according to FIG. 1 in a socket connector;

FIG. 5 shows a schematic perspective view of a second embodiment of a socket; and

FIG. 6 shows a schematic cross sectional front view of the embodiment of FIG. 5.

### DETAILED DESCRIPTION OF THE INVENTION

In the figures, two embodiments of a socket 20 for a high-voltage socket connector 100 are shown. The high-voltage socket connector 100 can comprise further elements that are not depicted, in particular at least one insulating housing part or a further contact element.

The socket connector 100 is adapted for being plugged together with a mating plug connect-or 200, of which only one contact element 210 in the form of the pin 220 is depicted. For making the electrical contact, the pin 220 is inserted into a pin receptacle section 40 of the socket 20 along a mating direction M, which in the depicted embodiments is parallel to an axial direction A of the pin receptacle section 40. A shaft 240 of the pin 220 is then in contact with contact arms 70 of the socket connector 100. At a distal connection section 270, the contact element 210 can be connected for example to a flexible or rigid conductor. In an operational state, the contact arms 70 are inclined radially inwards into an inner space 140 of the pin receptacle section 40. They protrude into the path of the pin 220 and are automatically deflected when the pin 220 is inserted. The pin receptacle section 40 is formed as a sleeve 49 that surrounds the pin 220 in the mated state.

The contact arms 70 are arranged behind each other in the circumferential direction C and behind each other in the mating direction M. Further, they extend in opposing directions, namely substantially along and counter to the mating direction M.

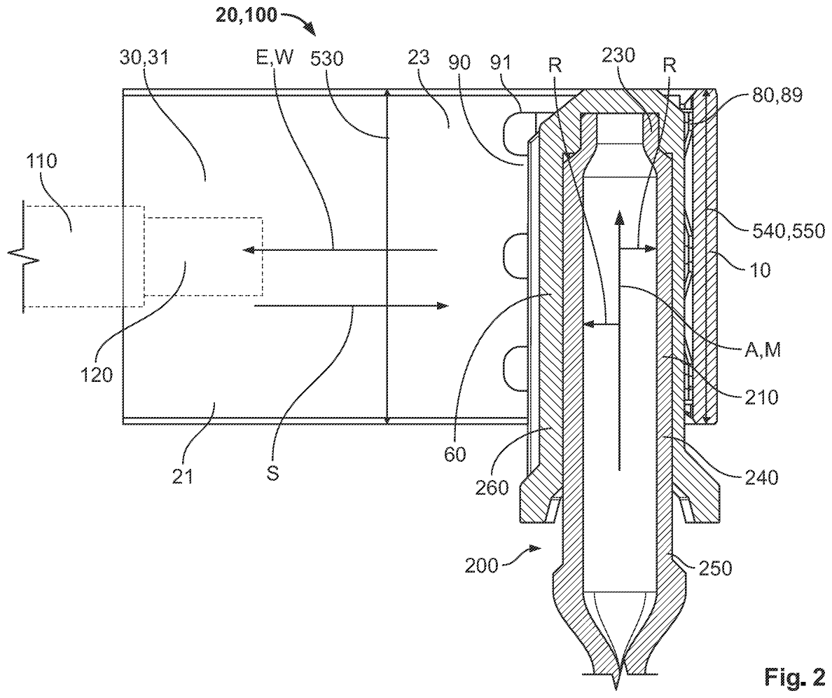

The socket 20 further comprises a conductor connection section 30 configured for making contact to a conductor, for example a wire 120 of a cable 110 (shown in phantom lines in FIG. 2) attached to the socket connector 100. In the depicted embodiments, the conductor connection section 30 is a flat section 31 that is used for making an ultrasonic welding connection with the wire 120. In other embodiments, different connection mechanisms can be used, for example soldering or crimping.

The cable 110 extends away from the socket 20 along a conductor connection direction W that is perpendicular to the mating direction M. In the exemplary embodiments, the plane of the flat section 31 is parallel to the mating direction M. Advantageously, the pin receptacle section 40 is located completely in one of the two half-spaces that are defined or delimited by the plane of the conductor connection section 30. This reduces the bending steps during the production.

In alternatives, this plane could be oriented differently, for example by introducing a twisted section between the conductor connection section 30 and the pin receptacle section 40. The plane of the flat section 31 could then for example be perpendicular to the mating direction M.

The conductor connection section 30 extends along an extension direction E, which is at a right angle to the mating direction M away from the pin receptacle section 40. It is located at a side of the pin receptacle section 40.

The pin receptacle section 40 is integral with the conductor connection section 30. The pin receptacle section 40 and the conductor connection section 30 are formed from a single sheet 23, namely a metal sheet, by cutting and bending. If rolled into a flat shape, a piece with a rectangular outer shape when viewed from above results.

In each of the two cases, the pin receptacle section 40 comprises at least two free ends 41, 42 extending in opposite circumferential directions around the mating direction M and at least in sections facing each other. Namely, a first free end 41 extends along a circumferential di-rection C and several second free ends 42 extend counter to the circumferential direction C. The first and the second free ends 41, 42 are at least in sections located at the same insertion depth along the mating direction M.

Two end faces 46, 47 located on the two free ends 41, 42 face each other and form a circumferential gap between them.

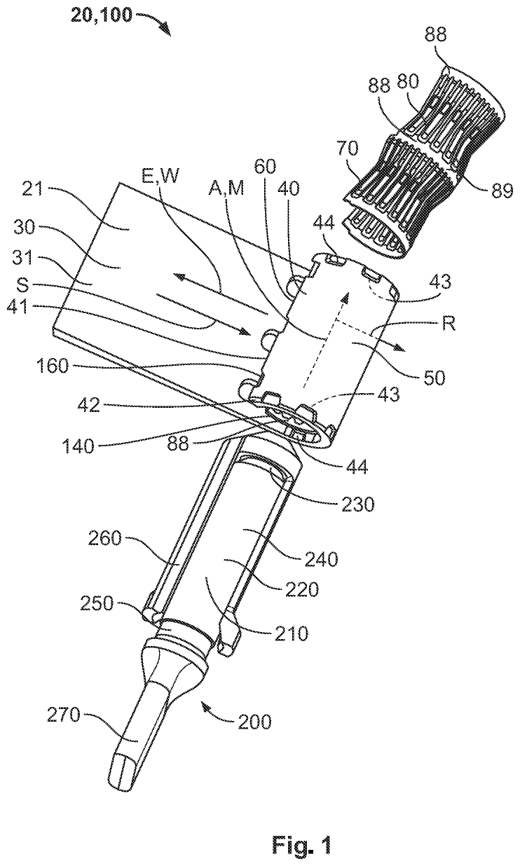

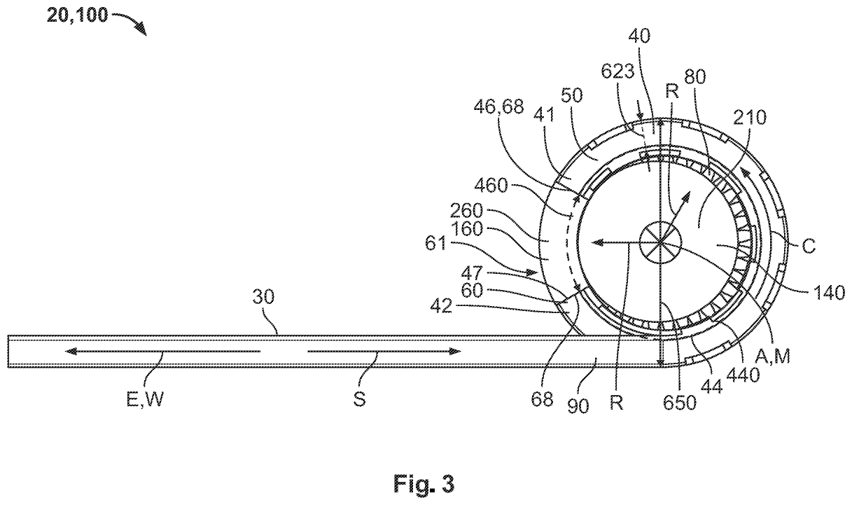

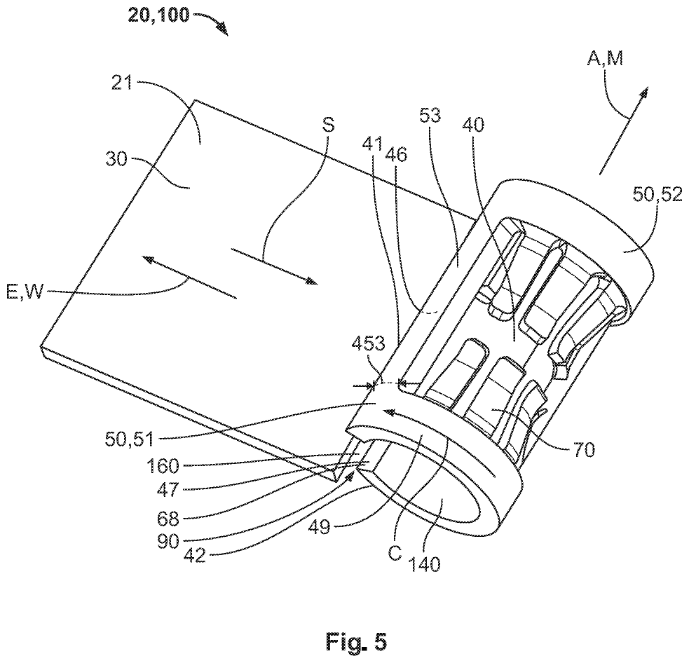

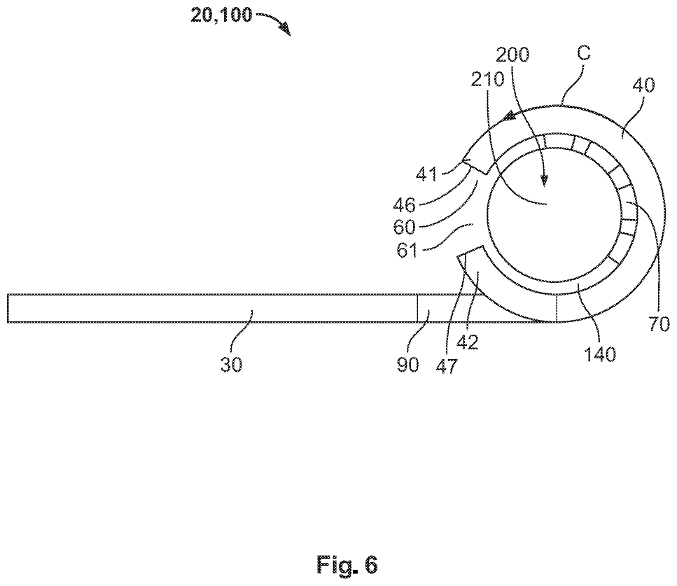

The pin receptacle section 40 comprises at least one open support ring section 50 for radially and axially supporting the at least one deflectable contact arm 70. In the embodiment of FIGS. 1 to 4, a single open support ring section 50 is present, while the embodiment of FIGS. 5 and 6 comprises two open support ring sections 50, 51, 52 located on opposite ends of the socket 20. In the latter case, the two open support ring sections 50, 51, 52 are integral with and connected via a stabilizing bridge 53 running parallel to the mating direction M. A circumferential width 453 of the stabilizing bridge 53 is such that sufficient mechanical support is provided. However, In order to reduce the weight, the circumferential width 453 should not be too big. Advantageously, the stabilizing bridge 53 is located at or forms the first free end 41.

The open support ring sections 50 have a basically constant clear cross section and a basically constant cross section along the mating direction M and thus a cylindrical inner and outer shape.

The pin receptacle section 40 and the open support ring sections 50 are open along and counter to the mating direction M. Outermost locations along the mating direction M are part of the open support ring sections 50 and form entrances for the pin 220.

The socket 20 comprises a radially open coding channel 60 adapted to fittingly receive a coding element 260 on the pin 220 along the mating direction M. The coding elements are keying features or polarization features used to avoid incorrect or accidental mating. In the depicted examples, the coding element 260 has a constant cross section along the mating direction M. It is formed as a bar that extends from a tip 230 to a base 250 of the pin 220 and protrudes in a radial direction R perpendicular to the mating direction M away from the shaft 240. The coding element 260 is in this example made from an insulator material, for example a plastic.

The coding channel 60 of the socket 20 extends in the mating direction M or axial direction A and has at each point along the mating direction M a clear cross section that is at least as big as the cross section of the coding element 260.

In order to have a good supportive effect from the pin receptacle section 40, a circumferential width 460 of the coding channel 60 should be kept small. However, a certain free width is necessary so that the mating coding element 260 can be wide and stable enough. The circumferential width 460 of the coding channel 60 can for example be compared to a circumferential length 440 of a closed envelope running along the inner cross section of the pin receptacle section 40. In the depicted embodiments, the ratio is about 1:6 (16.67%) corresponding to an angle of 60° of the coding channel 60 (of 360° of the closed envelope) when viewed from a central axis of the pin receptacle section 40.

The coding channel 60 is open towards an open inner space 140 of the pin receptacle section 40. A coding space 160 and the open inner space 140 are continuously connected parts of a single open space. In the depicted embodiments, the open support ring section 50 is radially open at the coding channel 60.

The open support ring sections 50 form at least a part of the coding channel 60. The end faces 46, 47 form parts of the sidewalls of the coding channel 60.

The socket 20 comprises a transition section 90 between the conductor connection section 30 and the pin receptacle section 30. The transition section 90 has a lower cross sectional area than the conductor connection section 40 and the pin receptacle section 30. This cross section is taken perpendicular to a direction S running from the conductor connection section 30 to the pin receptacle section 40. The direction S is thus counter to the conductor connection direction W and the extension direction E.

The lower cross sectional area is a result of the manufacturing process, in particular, the cut-ting and bending of unilaterally joined parts for forming the second free ends 42. Openings or recesses in the transition section 90 correspond to the unilaterally joined parts that form parts of the pin receptacle section 40.

In the first embodiment, the contact arms 70 are parts of a spring element 80 or spring sleeve 89 that is separate from the conductor connection section 30. The contact arms 70 protrude from open base rings 88 of the spring element 80. To hold the spring element 80 in place, opposing stop faces 43 located on inwardly protruding protrusions 44 are present in the pin receptacle section 40. The protrusions 44 are formed by deforming the sheet 23 at the ends of the part that will be the open support ring section 50.

As shown in FIGS. 5 and 6, the contact arms 70 can be integral with the open support ring sections 50. The spring sleeve 89 is here integral with the pin receptacle section 40, the open support ring sections 50, and the rest of the socket 20. The entire socket 20 is an integral part 21.

Lengths 550 of the open support ring sections 50 in the second embodiment are such that they provide stability while keeping the overall weight low. In the embodiment of FIGS. 5 and 6, the ratio of the length 550 to a length 540 of the pin receptacle section 40 is about 15%. In the first embodiment of FIGS. 1 to 4, the two lengths 550, 540 are about equal.

Further, in both embodiments, the conductor connection section 30 does not protrude over the pin receptacle section 40 along and counter to the mating direction M.

In both embodiments, a length 530 of the conductor connection section 30 equals a length of the pin receptacle section 540, the lengths 530, 540 being measured along the mating direction M.

A ratio of a sheet thickness 623 to the outer diameter 650 of the open support ring section(s) 50 (which is identical to the outer diameter of the pin receptacle section 40) is approximately 15%.

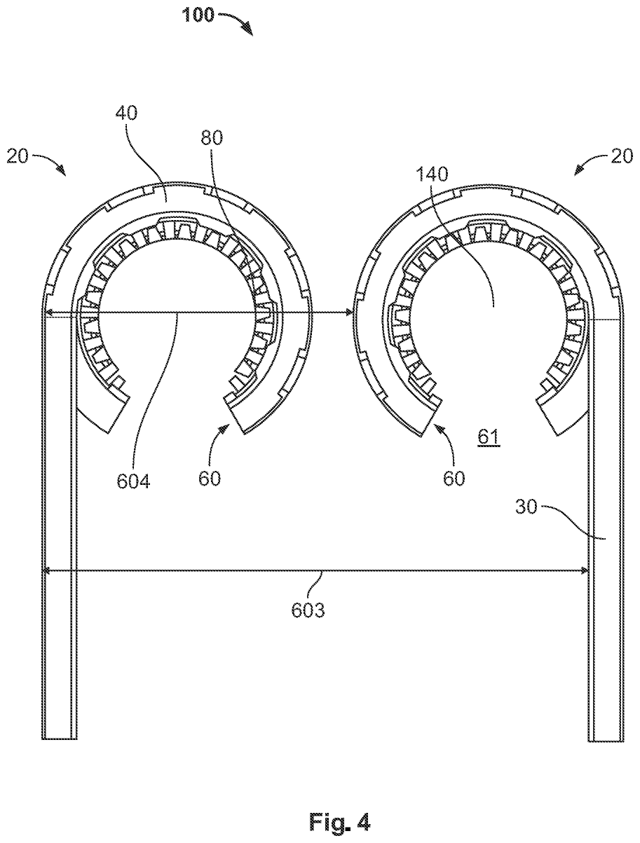

Both embodiments of a socket 20 are mirror-symmetric, with the mirror plane being perpendicular to the mating direction M. This allows the use in different orientations and the plugging in at both open ends. Furthermore, as shown in FIG. 4, the sockets 20 can be arranged in a connector 100 such that an offset 603 between two parallel conductor connection sections 30 is greater than an offset 604 between the pin receptacle sections 40 of neighboring sockets 20.

The coding element 260 of the exemplary embodiments shown in the figures is adapted to act as a touch protection bar. This bar can be a part of a touch protection arrangement (not shown in detail), by which contacting of the electrically conductive parts of the pin 220 with a finger is made impossible, in the assembled state. The touch protection arrangement can for example further comprise a channel-shaped housing part in which the pin is arranged with the touch protection bar/coding element 260 oriented towards the open face of the channel.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. Socket for a high-voltage socket connector, the socket comprising:
a conductor connection section adapted for being connected to a conductor of a cable, and a pin receptacle section adapted for receiving a pin of a mating plug connector along a mating direction, wherein the pin receptacle section is integral with the conductor connection section, and wherein the pin receptacle section includes at least two free ends that extend in opposite circumferential directions around the mating direction and at least in sections face each other.

2. Socket according to claim 1, wherein the pin receptacle section includes at least one open support ring section for radially and axially supporting at least one deflectable contact arm adapted for contacting the pin in a mated state.

3. Socket according to claim 1, wherein the socket includes a radially open coding channel adapted to fittingly receive a coding element on the pin along the mating direction.

4. Socket according to claim 3, wherein the coding channel is open towards an open inner space of the pin receptacle section.

5. Socket according to claim 3, wherein the open support ring section forms at least a part of the coding channel.

6. Socket according to claim 3, wherein the at least two free ends partially delimit the coding channel.

7. Socket according to claim 2, wherein the socket includes at least two open support ring sections.

8. Socket according to claim 2, wherein the at least one contact arm is integral with the open support ring section.

9. Socket according to claim 1, wherein the socket is monolithic.

10. Socket according to claim 1, wherein the at least one contact arm is part of a spring element that is separate from the conductor connection section.

11. Socket according to claim 1, wherein the socket is a stamped and/or bent part formed from a sheet.

12. Socket according to claim 1, wherein the socket includes a transition section between the conductor connection section and the pin receptacle section, the transition section having a lower cross sectional area than the conductor connection section.

13. Socket connector comprising:
at least two sockets, each socket including a conductor connection section adapted for being connected to a conductor of a cable, and a pin receptacle section adapted for receiving a pin of a mating plug connector along a mating direction, wherein the pin receptacle section is integral with the conductor connection section, and wherein the pin receptacle section includes at least two free ends that extend in opposite circumferential directions around the mating direction and at least in sections face each other;
wherein the conductor connection sections of at least two sockets are parallel and arranged at an offset greater than an offset of the corresponding pin receptacle sections.

14. Socket connector according to claim 13, wherein the pin receptacle section includes at least one open support ring section for radially and axially supporting at least one deflectable contact arm adapted for contacting the corresponding pin in a mated state.

15. Socket connector according to claim 13, wherein the socket includes a radially open coding channel adapted to fittingly receive a coding element on the pin along the mating direction.

16. Socket connector according to claim 13, wherein the at least one contact arm is part of a spring element that is separate from the conductor connection section.

17. Connection assembly comprising:
a socket including a conductor connection section and a pin receptacle section, the conductor connection section adapted for being connected to a conductor of a cable, the pin receptacle section is integral with the conductor connection section, the pin receptacle section includes at least two free ends that extend in opposite circumferential directions around the mating direction and at least in sections face each other; and
a pin-shaped contact element for a plug connector, the pin-shaped contact element received in the pin receptacle section along a mating direction.

18. Connection assembly according to claim 17, wherein the contact element includes a radially protruding coding element that extends parallel to the mating direction from a tip to a base of the contact element.

19. Connection assembly according to claim 17, wherein the pin receptacle section includes at least one open support ring section for radially and axially supporting at least one deflectable contact arm adapted for contacting the corresponding pin in a mated state.

20. Connection assembly according to claim 17, wherein the socket includes a radially open coding channel adapted to fittingly receive a coding element on the pin along the mating direction.
